(19) United States
(12) Patent Application Publication
(10) Pub. No.: US 2004/0239884 A1
(43) Pub. Date: Dec. 2, 2004

(54) Multiple-projection system

(75) Inventors: Yasuo Nagashima, Kawagoe City (JP); Yoshiro Suzuki, Hachioji City (JP); Akihiro Kubota, Kokubunji City (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/802,475

(22) Filed: Mar. 16, 2004

(30) Foreign Application Priority Data
Mar. 31, 2003 (JP) 2003-96189

(51) Int. Cl. G03B 21/26; G02B 9/14

(52) U.S. Cl. 353/30

(57) ABSTRACT

A multiple-projection system capable of stably observing high-definition and high quality images and capable of corresponding to the switching of the routes promptly, without irregular color etc. and without performing calibration at each switching of routes, is provided. A multiple-projection system for projecting one image on a screen 5 by two or more projectors 4, comprises a plurality of switchable routes for observing an image projection, a compensation data preservation sections 21a, 21b for storing compensation data to correct output characteristic of respective projectors 4 corresponding to respective routes, and an image processing section 22 for correcting and processing the input image signal based on the compensation data stored in the compensation data preserving section corresponding to the route used.

### BACKGROUND OF INVENTION

1. Field of the Invention

The present invention relates to a multiple-projection system for projecting one image on a screen by plural projectors.

2. Description of Related Art

As a conventional multiple-projection system, for example, there has been known that a test image is memorized in a test image memory section in order to realize a large seamless screen, the test image is supplied to respective projectors to project it on the screen, the projected test image is captured in the image information captured unit, the compensation data is calculated based on the captured image data to memorize the calculated data in the compensation data memory unit previously, and in the case of displaying the projection of a real input image, the picture data divided and inputted in response to respective projectors is compensated by using the compensation data memorized in the compensation data memory unit (for example, refer to Japanese Patent Application Opened No. 72,359/2002.).

In the multiple-projection system disclosed in Japanese Patent Application Opened No. 72,359/2002, the test image is projected to calculate the compensation data under a real projection conditions so that even in the case of the plane with an arbitrary shape of the screen, the geometrical distortion, the irregular color, and the shading or the like of the projected image can be corrected with accuracy, and thus high-definition and high quality projected images can be realized.

By the way, in the multiple-projection system, a plurality of image projecting light sources are provided switchably to respective projectors, the image projection observing route is switched by switching the light source, a plurality of screens having different characteristics are switchably provided, and the image projection observing route is switched by switching the screens. Moreover, such as in cases of observing the image with sit-down conditions, of observing the image while having stood, or of displaying the image for children, and of displaying the image for adults, the plural viewpoint positions observing the projected image are switchably set to switch the image projection observing route by switching the viewpoint positions.

In this way, in case of having a plurality of switchable routes for observing an image projection, the irregular color etc. cause slightly when the route is switched, so that the compensation of the input image is necessary in accordance with the route.

However, in the multiple-projection system described in the above Japanese Patent Application Opened No. 72,359/2002, the compensation data under real projection conditions, that is, only the compensation data in a specific route is stored in the compensation data memory unit, so that whenever the route is switched, each time the calibration is performed to operate the compensation data, and the operated compensation data must be stored in the compensation data memory portion.

Therefore, the operation becomes troublesome, and in the case of switching the route while observing the image, it is feared that the observation interruption time becomes long owing to calibration.

### SUMMARY OF THE INVENTION

Therefore, the present invention has for its object to provide, by paying an attention to this respect, a multiple-projection system capable of stably observing high-definition and high quality images and capable of responding to the switching of the routes promptly, without irregular color etc. and without performing calibration at each switching of routes.

In order to achieve the above object, according to the present invention, there is provided a multiple-projection system for projecting one image on a screen by plural projectors, comprising a plurality of switchable routes for observing an image projection, a compensation data preservation section for storing compensation data for correcting output characteristic of the projector corresponding to respective routes, and an image processing section for correcting and processing the input image signal based on the compensation data stored in the compensation data preserving section corresponding to the route used.

According to the present invention, the multiple-projection system is a calibration means for calculating the compensation data in respective routes to store the data in the corresponding compensation data preserving section.

In the multiple-projection system according to the present invention, the calibration means comprises a test image sending section for projecting and displaying the test image on the screen from the plural of projectors.

In the multiple-projection system according to the present invention, the calibration means comprises any one of a CCD camera for detecting the test image projected and displayed on the screen, a spectrometer, a calorimeter and a digital camera.

In the multiple-projection system according to the present invention, a plurality of image projecting light sources are provided switchably to respective projectors to switch the route by switching the light sources.

In the multiple-projection system according to the present invention, the plural viewpoint positions observing the projection profile on the screen, are switchably set, and the route is switched by switching the viewpoint positions.

In the multiple-projection system according to the present invention, as the screen, a plurality of screens having different characteristics, are switchably provided, and the route is switched by switching the screen.

According to the present invention, the compensation data in the plural switchable image projection observing routes are stored in the compensation data preserving section, respectively, and the input image signal is compensated and processed based on the compensation data stored in the compensation data preserving section corresponding to the route used, so that the switching of the routes can be corresponded promptly, without performing calibration again at each switching of routes, and images with high-definition and high quality without irregular color etc. can be observed stably.

### BRIEF DESCRIPTION OF THE DRAWING

FIG. 1 is a diagram explaining the calibration operation of the multiple-projection system according to the first embodiment of the present invention;

FIG. 2 is a view for explaining the output operation of the outer image, similarly;

FIG. 3 is a diagram explaining the calibration operation of the multiple-projection system according to the second embodiment of the present invention;

FIG. 4 is a view for explaining the output operation of the outer image, similarly;

FIG. 5 is a diagram explaining the calibration operation of the multiple-projection system according to the third embodiment of the present invention; and

FIG. 6 is a view for explaining the output operation of the outer image, similarly.

### DETAILED DESCRIPTION OF THE PREFERRED EMBODIMENT

Hereafter, the embodiments of the multiple-projection system according to the present invention is explained referring to the drawing.

First embodiment

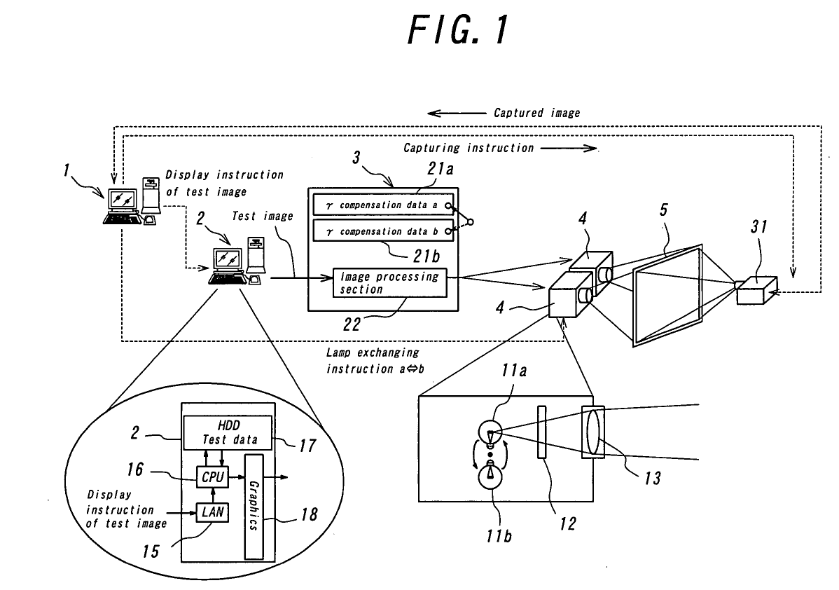

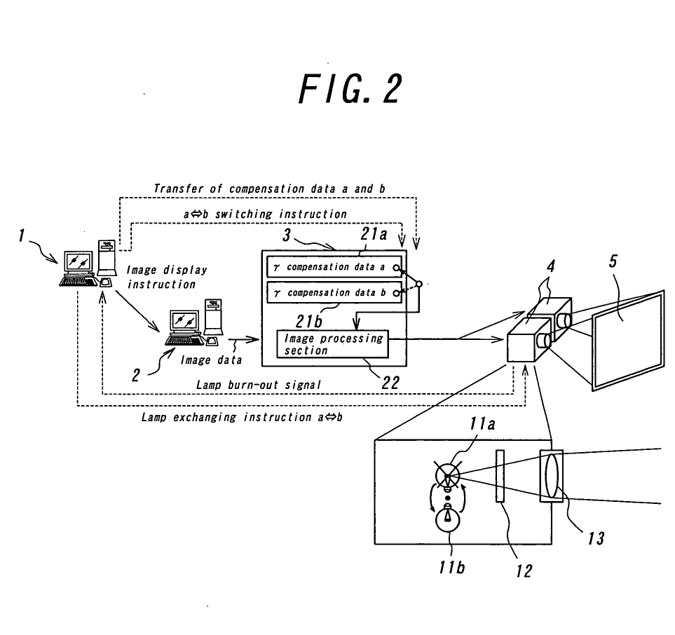

FIGS. 1 and 2 show first embodiment of the present invention, FIG. 1 is a view for explaining the calibration operation, and FIG. 2 is a view for explaining the output operation of the outer image. The multiple-projection system outputs the required image signal from an image output device 2 consists of PC similarly, under the control of a control device 1 consisting of a personal computer (PC), the compensation of the image signal is compensated by an image color correction circuit 3 and is divided and supplied to plurality of (here two) projectors 4, thereby projecting and displaying one image on a common screen 5 by plural projectors 4.

In this embodiment, respective projectors 4 are constituted with the liquid crystal projectors, and its operation is controlled with the control device 1. In respective projectors 4, as shown in FIGS. 1 and 2 with partially expanded state, two image projecting lamps (light source) 11a and 11b are provided switchably at given positions, and the image displayed on a liquid crystal panel 12 is projected and displayed on the screen 5 by a projection lens 13 by lighting the lamp (lamp 11a for example) at given position. That is, in this embodiment, two image projection observing routes are provided switchably by providing two lamps 11a and 11b to respective projectors 4, switchably.

The image output device 2 constitutes a test image sending section, and has a LAN board 15, a control unit (CPU) 16, a memory (HDD) 17 and a graphic boards 18, the test data for test image is previously stored in the memory 17, the test data is read from the memory 17 under the control of the control unit 16, in synchronized with the reception of the display instruction of the test image from the control device 1 by the LAN board 15, at the calibrating, and the test data is supplied to the image color correction circuit 3 as a test image from the graphics board 18.

Moreover, various external image signals (PC, VTR, and HDTVVTR, etc.) can be input to the image output device 2, and the external image signal input by the image display instruction from control device 1 is supplied to the image color correction circuit 3.

The image color correction circuit 3 is provided with compensation data preserving sections 21a, 21b and an image processing section 22 corresponding to the image projection observing route, the compensation data (for example, γ compensation data) for correcting the output characteristic of the projectors 4 in respective routes, are stored in the corresponding compensation data preserving section 21a and 21b by for example the lookup table system, under the control of the control device 1, and in the case of projecting and displaying the external image signals, the compensation data preserving section corresponding to the utilized route is selected, and the compensation data stored in it is supplied to the image processing section 22, thereby correcting the input image signal every projector 4.

In this embodiment, the route using one lamp 11a is made a first route, and the route using the other lamp 11b is made a second route, for respective two projectors 4, the γ compensation data in each route are obtained by performing previous calibration, and these γ compensation data are stored in the compensation data preserving sections 21a and 21b corresponding to the image color correction circuit 3.

Therefore, at the calibrating time, as shown in FIG. 1, first, the lamp exchanging instruction is given to two projectors 4 from the control device 1, one lamp 11a is positioned and lighted at the given position respectively, and the display instruction of the test image is given to the image output device 2 from the control device 1, and thus the test image is divided and supplied to two projectors 4 to project and display the test image on the screen 5 without correcting and processing the test image by the image processing section 22 of the image color correction circuit 3.

Moreover, a calibration camera 31 having, for example, a CCD camera for the monochrome and a color filter, is arranged controllably with the control device 1, forward of the screen 5, the test image displayed on the screen 5 is captured and the captured image is supplied to the control device 1, by giving the capturing instruction from the control device 1 to the calibration camera 31, and γ compensation data a for respective projectors 4 in the first route is calculated in the control device 1 based on the captured image.

Afterwards, in the same way, the lamp exchange instruction is given to two projectors 4, the other lamp 11b is positioned at the given position respectively, to project and display the test image on the screen 5, and the test image is captured by the calibration camera 31 and then γ compensation data b of respective projectors 4 in the second route is calculated with the control device 1. Herein, the control device 1, the image output device 2, and the calibration camera 31 constitute a calibration means.

When γ compensation data a and b in respective routes are calculated with the control device 1 by the above calibration, these γ compensation data are transferred to the image color correction circuit 3 to store them in the compensation data preserving sections 21a and 21b corresponding to the route, thereby preparing for the projection display of the external image signal input to the image output device 2.

Afterwards, in the case of projecting the external image signals, in the control device 1, the lamp used by two projectors 4, that is, the route is detected, the compensation data preserving section of image color correction circuit 3 is selected in accordance with the utilizing route, the γ compensation data stored in the compensation data preserving section are supplied to the image processing section 22, thereby dividing and supplying the external image signals to two projectors 4 after compensation and process of the external image signals, and thus projecting and displaying one image on the screen 5. For example, in the case of using the first route, by selecting the compensation data preserving section 21a, the external image signal is compensated and processed with the use of γ compensation data a in the image processing section 22, thereby projecting and displaying the image.

Here, when the lamp 11a of arbitrary projector 4 is burnt-out, in the state of using the first route, that is, in the state of using the lamp 11a in respective projectors 4, and the lamp burn-out signal output from the projector 4 in the control device 1 is detected, the lamp exchanging instruction is given to two projectors 4 from the control device 1 in synchronized with the detection of the lamp burn-out signal, and the utilized lamp is switched to the lamp 11b, thereby exchanging the lamp from the first route to the second route.

At the same time, the switching instruction of the compensation data is given from the controller 1 to the image color correction circuit 3, the compensation data preservation portion 21b corresponding to the second route is selected, as a result, the image is projected and displayed by using the γ compensation data b in the image processing section 22 and correcting and processing an external image signal.

Thus, in this embodiment, the γ compensation data a of the first route using the lamp 11a and the γ compensation data b of the second route using the lamp 11b for two projectors 4 are previously obtained by calibration and are stored in the corresponding compensation data preserving sections 21a and 21b, and in the case of displaying an external image signal, the compensation data preserving section corresponding to the route to be used is selected, thereby correcting and processing the external image signal by the γ compensation data corresponding to the route, so that in the case of switching the route by the lamp burn-out, the switching of the route can be corresponded promptly, by selecting the compensation data preserving section corresponding to the switched route without performing calibration again, and thus images with high-definition and high quality without irregular color etc. can be observed stably.

Second Embodiment

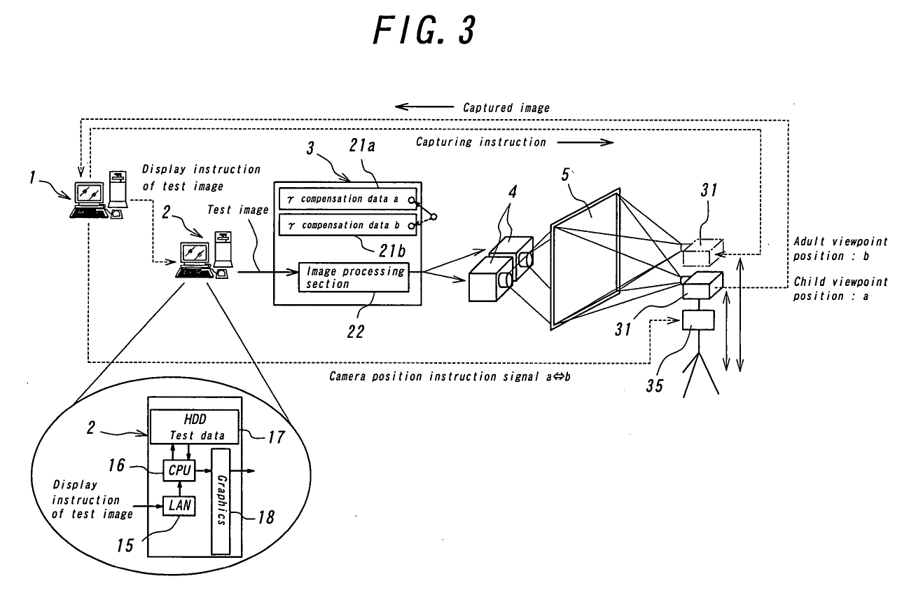

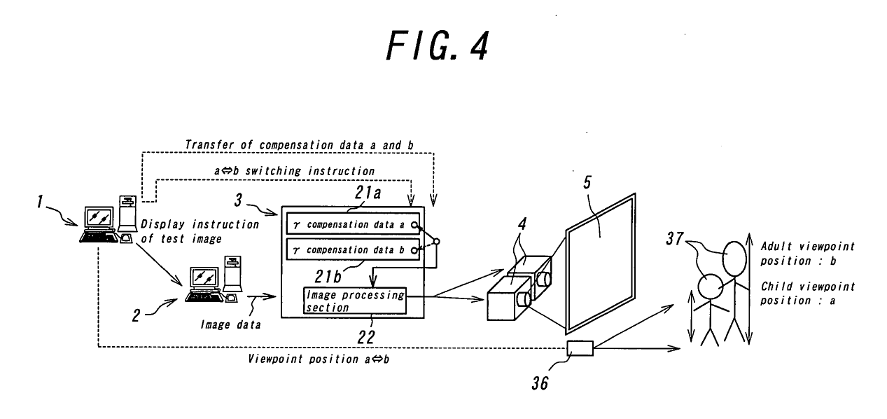

FIGS. 3 and 4 are views for showing the second embodiment of the present invention, FIG. 3 is a view for explaining the calibration operation, and FIG. 4 is a view for explaining the output operation of the outer image.

In this embodiment, the viewpoint position of the projected image observed by the child, is made to be first route, the viewpoint position of the projected image observed by the adult, is made to be second route, the γ compensation data in each route are obtained by performing previous calibration, these γ compensation data are stored in the compensation data preserving sections 21a and 21b corresponding to the image color correction circuit 3, in the case of displaying an external image signal, the compensation data preserving section corresponding to the route to be used is selected, thereby correcting and processing the external image signal by the γ compensation data corresponding to the route, and thus other constitutions are the same as those of the first embodiment, so that the same numeral reference is attached to the same constructional elements as that of the first embodiment, and the detailed explanation thereof is omitted.

Therefore, at the time of calibrating, as shown in FIG. 3, first, the calibration camera 31 is matched to child's viewpoint position through a position adjusting device 35 according to the camera position instruction signal from the control device 1. In this condition, the display instruction of the test image is given to the image output device 2 from the control device 1, thereby projecting and displaying the test image on the screen, and the test image thus displayed is captured by the calibration camera 31 placed at child's viewpoint position and then γ compensation data b of respective projectors 4 in the second route is calculated by the control device 1.

Afterwards, in the same way, the calibration camera 31 is matched to an adult's viewpoint position through the position adjusting device 35 according to the camera position instruction signal from the control device 1, and the test image imaged and displayed on the screen under this condition, is captured by the calibration camera 31 and then γ compensation data b of respective projectors 4 in the second route is calculated with the control device 1.

As described above, when γ compensation data a and b in respective routes are calculated with the control device 1, as shown in FIG. 4, these γ compensation data are transferred to the image color correction circuit 3 to store them in the compensation data preserving sections 21a and 21b corresponding to the route, thereby preparing for the projection and display of the external image signal input to the image output device 2.

Afterwards, in the case of projecting the external image signals, for example, a height detector 36 detects whether a viewer 37 is a child or an adult automatically, or, the child or the adult is selected with a selection switch, the compensation data preserving section of the image color correction circuit 3 is selected with the control device 1 according to the viewpoint position of the viewer 37, that is, the route to be used, and the γ compensation data stored in the compensation data preserving section are supplied to the image processing section 22, thereby dividing and supplying the external image signals to two projectors 4 after compensation and process of the external image signals, and thereby projecting and displaying the one image on the screen.

That is, in the case of the first route being child's viewpoint position, the compensation data reserving section 21a is selected and the external image signal is compensated and processed with the use of γ compensation data a in the image processing section 22, thereby projecting and displaying the image, and in the case of the second route being an adult viewpoint position, the compensation data reserving section 21b is selected and the external image signal is compensated and processed with the use of γ compensation data b in the image processing section 22, thereby projecting and displaying the image.

In this way, in this embodiment, the γ compensation data a of the first route being child's viewpoint position and the γ compensation data b of the second route being an adult viewpoint position, are previously obtained by calibration and are stored in the corresponding compensation data preserving sections 21a and 21b, in the case of displaying the external image signal, the compensation data preserving section corresponding to the route to be used is selected, thereby correcting and processing the external image signal by the γ compensation data corresponding to the route, so that in the case of changing the viewer 37 from the child to the adult and in the case of changing viewer 37 from the adult to the child oppositely, the switching of the route can be corresponded promptly, by selecting the compensation data preserving section corresponding to the switched route without performing calibration again, and thus images with high-definition and high quality without irregular color etc. can be observed stably.

Third Embodiment

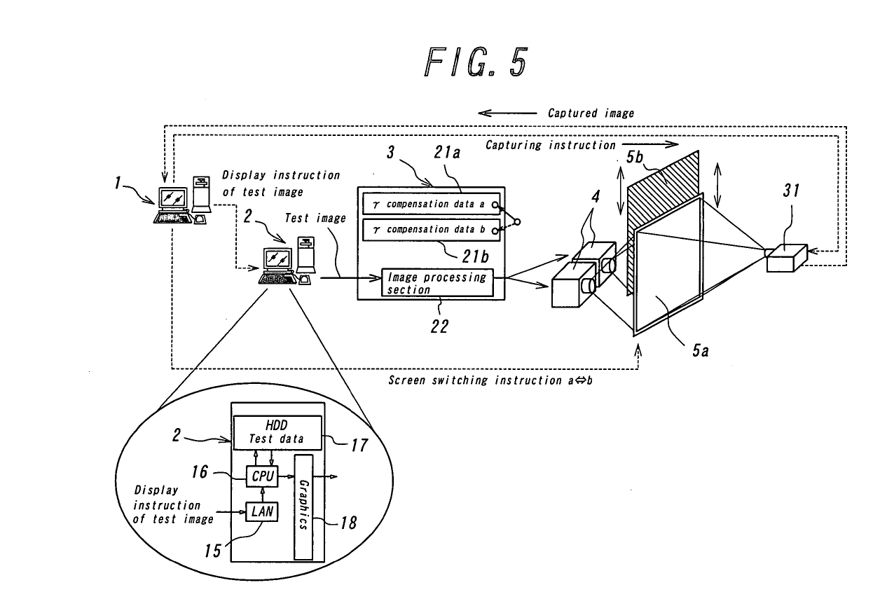

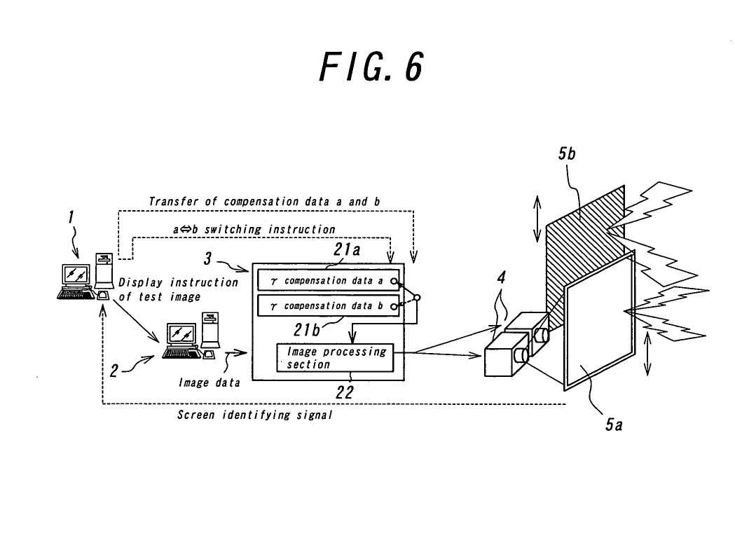

FIGS. 5 and 6 show third embodiment of the present invention, FIG. 5 is a view for explaining the calibration operation, and FIG. 6 is a view for explaining the output operation of the external image.

In this embodiment, in the multiple-projection system, in which two screens 5a and 5b having different screen characteristic (orientation characteristic, reflectance characteristic, and a direction of the reflection etc.) are used to switch these screens according to the image to be projected and displayed, the case for using the screen 5a is made to be first route, the case for using the screen 5b is made to be second route, the γ compensation data in each route are obtained by performing previous calibration, these γ compensation data are stored in the compensation data preserving sections 21a and 21b corresponding to the image color correction circuit 3, in the case of displaying an external image signal, the compensation data preserving section corresponding to the route to be used is selected, thereby correcting and processing the external image signal by the γ compensation data corresponding to the route, and thus other constitutions are the same as those of the first embodiment, so that the same numeral reference is attached to the same constructional elements as that of the first embodiment, and the detailed explanation thereof is omitted.

Therefore, at the time of calibration, as shown in FIG. 5, first, the screen 5a is used by the screen switch instruction from the control device 1, under this condition, the display instruction of the test image is given to the image output device 2 from the control device 1, thereby projecting and displaying the test image on the screen 5a, and the test image thus displayed is captured by the calibration camera 31 and then γ compensation data a of respective projectors 4 in the first route is calculated by the control device 1.

Afterwards, in the same way, the screen 5b is used by the screen switching instruction from the control device 1, and the test image projected and displayed on the screen 5b under such condition is captured by the calibration camera 31 and then γ compensation data b of respective projectors 4 in the second route is calculated with the control device 1.

As described above, when γ compensation data a and b in respective routes are calculated in the control device 1, as shown in FIG. 6, these γ compensation data are transferred to the image color correction circuit 3 to store them in the compensation data preserving sections 21a and 21b corresponding to the route, thereby preparing for the projection and display of the external image signal input to the image output device 2.

Afterwards, in the case of projecting the external image signals, the compensation data preserving section of the image color correction circuit 3 is selected by the control device 1, according to the screen identifying signal representing the screen 5a or 5b to be used, that is, the used route, the γ compensation data stored in the compensation data preserving section are supplied to the image processing section 22, thereby dividing and supplying the external image signals to two projectors 4 after compensation and process of the external image signals, and thereby projecting and displaying the one image on the screen.

That is, in the case of the first route for using the screen 5a for the screen identifying signal, the compensation data reserving section 21a is selected and the external image signal is compensated and processed with the use of γ compensation data a in the image processing section 22, thereby projecting and displaying the image, and in the case of the second route for using the screen 5b for the screen identifying signal, the compensation data reserving section 21b is selected and the external image signal is compensated and processed with the use of γ compensation data b in the image processing section 22, thereby projecting and displaying the image.

In this way, in this embodiment, the γ compensation data a of the first route using the screen 5a and the γ compensation data b of the second route using the screen 5b with property different from that of the screen 5a are previously obtained by the calibration to store these γ compensation data in the corresponding compensation data preserving sections 21a and 21b, and in the case of displaying the external image signal, the compensation data preserving section corresponding to the screen (route) to be used is selected, thereby correcting and processing the external image signal by the γ compensation data corresponding to the route, so that the switching of the route can be corresponded promptly, by selecting the compensation data preserving section corresponding to the switched route without performing calibration again, every switching between the screens 5a and 5b, and thus images with high-definition and high quality without irregular color etc. can be observed stably.

Moreover, the present invention is not limited to only the above embodiments, and thus many variations or modifications can be carried out. For example, in the first embodiment, two routes of the first route using the lamp 11a by two projectors 4, and the second route using the lamp 11b by two projectors 4, are provided, but a combination of all lamps for all projectors, that is, in the case of having two lamps 11a and 11b for two projectors 4, respectively, as described above, a total of four combinations are provided as respective routes, the compensation data of respective routes are previously obtained, these compensation data are stored in the corresponding compensation data preserving section, and thus the compensation data according to the route to be utilized may also be used.

Moreover, in the second embodiment, the route is switched according whether the viewer 37 is child or adult, but both in the case of observing the image with sit-down conditions of the viewer 37 and in the case of observing the image while having stood of the viewer 37, it is possible to apply also to the case that switches the route, similarly.

In addition, the present invention can also be constituted in such a manner that plural routes are set by properly combining the first to third embodiments and its modifications, the compensation data of respective routes are obtained by performing previous calibration to store these compensation data in the compensation data preserving sections, and the compensation data corresponding to the route to be used is used.

Moreover, the present invention is not limited to the above described multiple-projection system of rear projection type, and can also be applied to the multiple-projection system of forward projection type effectively, and is not limit to the case of displaying one image on one screen by the plural projectors in the seamless shape, the present invention may also be applied to the multiple-projection system, in which plural image display devices having the projector and the screen, are combined to display one image, effectively. Moreover, the calibration camera 31 can not be limited to the CCD camera, and may also be constituted by using a digital camera, a spectrometer or a colorimeter.

What is claimed is:

1. A multiple-projection system for projecting one image on a screen by plural of projectors comprising a plurality of switchable routes for observing an image projection, a compensation data preservation section for storing compensation data for correcting output characteristic of the projector corresponding to respective routes, and an image processing section for correcting and processing the input image signal based on the compensation data stored in the compensation data preserving section corresponding to the route used.

2. A multiple-projection system as claimed in claim 1, further comprising a calibration means for calculating the compensation data in respective routes to store the data in the corresponding compensation data preserving section.

3. A multiple-projection system as claimed in claim 2, wherein the calibration means comprises a test image sending section for projecting and displaying the test image on the screen from the plural of projectors.

4. A multiple-projection system as claimed in claim 2, wherein the calibration means comprises any one of a CCD camera for detecting the test image projected and displayed on the screen, a spectrometer, a calorimeter and a digital camera.

5. A multiple-projection system as claimed in claim 3, wherein the calibration means comprises any one of a CCD camera for detecting the test image projected and displayed on the screen, a spectrometer, a calorimeter and a digital camera.

6. A multiple-projection system as claimed in claim 1, wherein further comprising a plurality of image projecting light sources capable of switching them to respective projectors, and the route being switched by switching the light sources.

7. A multiple-projection system as claimed in claim 1, wherein the plural viewpoint positions observing the projection profile on the screen, are switchably set, and, the route is switched by switching the viewpoint positions.

8. A multiple-projection system as claimed in claim 1, wherein as the screen, a plurality of screens having different characteristics, are switchably provided, and the route is switched by switching the screen.
